(19) United States
(12) Patent Application Publication
(10) Pub. No.: US 2022/0140607 A1
(43) Pub. Date: May 5, 2022

(54) STATION-HYBRID HIGH VOLTAGE DIRECT CURRENT SYSTEM AND METHOD FOR POWER TRANSMISSION

(71) Applicant: University of Tennessee Research Foundation, Knoxville, TN (US)

(72) Inventors: Yilu LIU, Knoxville, TN (US); Kaiqi SUN, Knoxville, TN (US); Huangqing XIAO, Knoxville, TN (US)

(21) Appl. No.: 17/085,595

(22) Filed: Oct. 30, 2020

(51) Int. Cl. H02J 3/36; H02M 7/219; H02M 7/162; H02M 7/521; H02M 7/5387

(52) U.S. Cl. CPC H02J 3/36; H02M 7/219; H02M 7/53871; H02M 7/521; H02M 7/1626

(57) ABSTRACT

A high voltage direct current (HVDC) transmission system comprises a first terminal comprising a first voltage source converter (VSC) having a first and second VSC terminals and a first line commutated converter (LCC) having first and second LCC terminals; a second terminal comprising a second VSC having third and fourth VSC terminals and a second LCC having third and fourth LCC terminals; and a transmission line pair comprising a positive transmission line that couples the first VSC terminal and the first LCC terminal of the first VSC and the first LCC, respectively, to the third VSC terminal and the third LCC terminal of the second VSC and the second LCC, respectively, and a second positive line that couples the second VSC terminal and the second LCC terminal of the first VSC and the first LCC, respectively, to the fourth VSC terminal and the fourth LCC terminal of the second VSC and the second LCC, respectively.

### STATEMENT REGARDING FEDERALLY SPONSORED RESEARCH OR DEVELOPMENT

This invention was made with government support under contract number NSF EEC-1041877 awarded by the National Science Foundation. The government has certain rights in the invention.

### BACKGROUND

The present disclosure relates to power systems, and, in particular, to high voltage direct current (HVDC) transmission systems used in power transmission.

A recent planning study has been undertaken to assess the degree to which interconnection can facilitate a more reliable, resilient, sustainable, and affordable U.S. electricity system. FIG. 1 shows the conceptual representation of the three major seams in the United States, the distribution of energy resources (solar, wind, and natural gas), and the population centers. The study results highlighted the urgent need for the cross-seam transmission system to achieve significant economic benefits, such as daily energy sharing across time zones, peak energy sharing between different regions, and ancillary services sharing, such as frequency response service.

There is an increased number of HVDC transmission systems being developed or planned throughout the world during the latest decade. The HVDC transmission systems have been used for connecting remote generation to load areas, offshore wind integration, and interconnection of synchronous or asynchronous AC networks of different regions or countries. Two basic converter technologies are used in modern HVDC transmission systems. These are classical line-commutated converters (LCCs) and self-commutated voltage source converters (VSCs). LCC-HVDC transmission systems have been widely used for long-distance power transmission connecting remote generation to load areas. Aided by developments of power electronic technology, VSC-HVDC transmission technology has been regarded as the main solution for future transmission system upgrading.

The cross-seam HVDC applications typically require high power delivery capability, flexible power flow control capability, and lower construction cost. In most of the LCC-HVDC transmission systems, the power flow is typically unidirectional, and power flow reversal operation may only be needed in certain special conditions. This is because the LCC-HVDC transmission system needs to reverse the polarity of DC line voltages to realize the direction change of power flow. During the reversal process, the HVDC system is in a shutdown state, and temporary power transmission interruption is unavoidable. This disadvantage may affect the power flow dispatch flexibility between interconnections. In addition, a large footprint of the converter station, strong AC system connection need, and limitation of intermediate tapping for renewables may further reduce the merit of LCC-HVDC transmission technology in cross-seam applications. Although VSC-HVDC transmission technology may control the power flow from each terminal in a coordinated manner so that it can reverse the power flow direction as desired without station interruption, the investment cost of VSC-HVDC technology remains relatively high compared to LCC-HVDC, which influences the popularization of VSC-HVDC technology in practice. Thus, a pure LCC or VSC transmission system is generally not appropriate for a cross-seam HVDC application.

A hybrid HVDC system may combine the advantages of VSC and LCC technologies. Hybrid HVDC systems may be sorted into three categories: 1) pole-hybrid system (LCC and VSC used in different poles), 2) converter-hybrid system (LCC and VSC forming one converter) and 3) terminal-hybrid system (LCC and VSC used in different terminals). The pole-hybrid HVDC system is a bipolar system in which one pole adopts LCC-HVDC and the other pole uses VSC-HVDC. The VSC in the pole-hybrid system can be used as reactive power compensation and as an active filter for the LCC. But in a monopolar HVDC system, this hybrid structure may not be used. In addition, there will be earth current if the DC currents in the two poles are different. The converter-hybrid HVDC system uses converters that are formed with an LCC and a VSC. Most research studies focus on the series converter-hybrid HVDC system with the LCC and the VSC connected in series. This topology is able to deal with DC faults by retarding the firing angle of rectifier LCC. With cooperative control of the LCC and the VSC, the current cut-off will not occur under AC faults at the sending system. In addition, supplying power for the weak AC grid can be achieved because there is a VSC in the converters. However, this topology may also have some disadvantages. As the direction of current flowing through the LCC cannot be changed, and the DC voltage of most VSC topologies is unable to be reversed, the power reversal may be difficult. Moreover, due to the series connection of LCC and VSC, the DC current flowing through them is the same. But the current range of VSC is far less than that of LCC. As a result, bulk-power transmission capability of LCC cannot be fully utilized. The terminal-hybrid HVDC system is mainly used to connect remote generation. Such terminal-hybrid HVDC systems have been considered for the integration of offshore wind farms, where the VSC is on the offshore platform operating as a rectifier, and the LCC is onshore operating as inverter. A terminal-hybrid HVDC system under development includes three terminals. The LCC terminal is located at a remote generation site operating as a rectifier, and the two VSC terminals are in load areas operating as inverters. Existing hybrid HVDC configurations are not appropriate for cross-seam HVDC transmission.

### SUMMARY

In some embodiments of the inventive concept, a high voltage direct current (HVDC) transmission system comprises a first terminal comprising a first voltage source converter (VSC) having a first and second VSC terminals and a first line commutated converter (LCC) having first and second LCC terminals; a second terminal comprising a second VSC having third and fourth VSC terminals and a second LCC having third and fourth LCC terminals; and a transmission line pair comprising a positive transmission line that couples the first VSC terminal and the first LCC terminal of the first VSC and the first LCC, respectively, to the third VSC terminal and the third LCC terminal of the second VSC and the second LCC, respectively, and a second positive line that couples the second VSC terminal and the second LCC terminal of the first VSC and the first LCC, respectively, to the fourth VSC terminal and the fourth LCC terminal of the second VSC and the second LCC, respectively.

In other embodiments, each of the first LCC and the second LCC are configured to operate in any of a plurality of LCC operating modes, the plurality of LCC operating modes comprising a constant DC current mode and a constant DC voltage mode; and each of the first VSC and the second VSC are configured to operate in any of a plurality of VSC operating modes, the plurality of VSC operating modes comprising a constant DC voltage mode, a constant active power mode, a constant reactive power mode, and a constant alternating current (AC) voltage mode.

In other embodiments, the first terminal and the second terminal are configured to reverse a first power flow direction from the first terminal to the second terminal to a second power flow direction from the second terminal to the first terminal.

In some embodiments of the inventive concept, a method comprises controlling power flow in a high voltage direct current (HVDC) transmission system on a transmission line pair between a first terminal and a second terminal, the first terminal comprising a first voltage source converter (VSC) having a first and second VSC terminals and a first line commutated converter (LCC) having first and second LCC terminals, the second terminal comprising a second VSC having third and fourth VSC terminals and a second LCC having third and fourth LCC terminals, and the transmission line pair comprising a positive transmission line that couples the first VSC terminal and the first LCC terminal of the first VSC and the first LCC, respectively, to the third VSC terminal and the third LCC terminal of the second VSC and the second LCC, respectively, and a second positive line that couples the second VSC terminal and the second LCC terminal of the first VSC and the first LCC, respectively, to the fourth VSC terminal and the fourth LCC terminal of the second VSC and the second LCC, respectively; configuring each of the first LCC and the second LCC to operate in any of a plurality of LCC operating modes, the plurality of LCC operating modes comprising a constant DC current mode and a constant DC voltage mode; and configuring each of the first VSC and the second VSC to operate in any of a plurality of VSC operating modes, the plurality of VSC operating modes comprising a constant DC voltage mode, a constant active power mode, a constant reactive power mode, and a constant alternating current (AC) voltage mode.

In further embodiments, the method further comprises configuring the first terminal and the second terminal in a first power flow direction from the first terminal to the second terminal.

In still further embodiments, configuring the first terminal and the second terminal in the first power flow direction comprises: configuring the first LCC in the constant DC current mode; configuring the second LCC in the constant DC voltage mode; configuring the first VSC in the constant active power mode; and configuring the second VSC in the constant active power mode.

In still further embodiments, the method further comprises configuring the first terminal and the second terminal in a second power flow direction from the second terminal to the first terminal.

In still further embodiments, configuring the first terminal and the second terminal in the second power flow direction comprises: configuring the second LCC in the constant DC current mode; decreasing active power of the first LCC and the second LCC to zero; and disconnecting the first LCC and the second LCC from the HVDC transmission system.

In still further embodiments, decreasing the active power of the first LCC and the second LCC to zero comprises decreasing the active power of the first LCC and the second LCC to zero using a constant ramping rate.

In still further embodiments, configuring the first terminal and the second terminal in the second power flow direction further comprises decreasing power flow on the transmission line pair to zero; and reversing voltage polarity of each of the first LCC and the second LCC.

In still further embodiments, decreasing the power flow on the transmission line pair to zero comprises adjusting a reference voltage of the first VSC.

In still further embodiments, configuring the first terminal and the second terminal in the second power flow direction further comprises: reconnecting the first LCC and the second LCC to the HVDC transmission system; configuring the second LCC in the constant DC voltage mode; configuring the second VSC in the constant active power mode; increasing the active power of the first LSC; and increasing active power of the first VSC and the second VSC.

In still further embodiments, the method further comprises detecting a frequency disturbance in the high voltage direct current (HVDC) transmission system; generating a power order deviation based on the frequency disturbance; controlling the first terminal and the second terminal using one of a plurality of emergency frequency support power control schemes.

In still further embodiments, controlling the first terminal and the second terminal comprises: increasing first and second power references of the first VSC and the second VSC, respectively, when a power support direction of the power order deviation is a same as a power flow direction of the HVDC transmission system and the power order deviation is less than a combined maximum power output of the first VSC and the second VSC.

In still further embodiments, controlling the first terminal and the second terminal comprises: increasing first and second power references of the first VSC and the second VSC to maximum power capacity, respectively, and increasing first and second power references of the first LCC and the second LCC, respectively, when the when a power support direction of the power order deviation is a same as a power flow direction of the HVDC transmission system and the power order deviation is less than a difference between a first sum of the maximum power capacities of the first VSC and the second VSC, respectively, and maximum power capacities of the first LCC and the second LCC, respectively, and a second sum of the first and second power references of the first VSC and the second VSC, respectively, and the first and second power references of the first LCC and the second LCC, respectively.

In still further embodiments, controlling the first terminal and the second terminal comprises: increasing first and second power references of the first VSC and the second VSC to maximum power capacity, respectively, and increasing first and second power references of the first LCC and the second LCC to greater than maximum capacity, respectively, when the when a power support direction of the power order deviation is a same as a power flow direction of the HVDC transmission system and the power order deviation is not less than a difference between a first sum of the maximum power capacities of the first VSC and the second VSC, respectively, and the maximum power capacities of the first LCC and the second LCC, respectively, and a second sum of the first and second power references of the first VSC and the second VSC, respectively, and the first and second power references of the first LCC and the second LCC, respectively.

In still further embodiments, controlling the first terminal and the second terminal comprises: decreasing first and second power references of the first VSC and the second VSC, respectively, when a power support direction of the power order deviation is different from a power flow direction of the HVDC transmission system and the power order deviation is less than a power reference of the first VSC and the second VSC.

In still further embodiments, controlling the first terminal and the second terminal comprises: decreasing first and second power references of the first VSC and the second VSC, respectively, and decreasing first and second power references of the first LCC and the second LCC, respectively, when a power support direction of the power order deviation is different from a power flow direction of the HVDC transmission system and the power order deviation is less than a sum of a power reference of the first LCC and the second LCC and a power reference of the first VSC and the second VSC.

In still further embodiments, controlling the first terminal and the second terminal comprises: configuring the second LCC in the constant DC voltage mode, configuring the second VSC in the constant active power mode, decreasing first and second power references of the first VSC and the second VSC, respectively, to zero, and decreasing first and second power references of the first LCC and the second LCC, respectively, to zero, and increasing power flow via the first VSC and the second VSC in a power flow direction of the power flow deviation when the power support direction of the power order deviation is different from a power flow direction of the HVDC transmission system and the power order deviation is less than a sum of a total power change of the first VSC and the second VSC from the power reference of the VSC to reversed maximum power and the power reference of the first LCC and the second LCC.

In still further embodiments, controlling the first terminal and the second terminal comprises: configuring the second LCC in the constant DC voltage mode, configuring the second VSC in the constant active power mode, decreasing first and second power references of the first VSC and the second VSC, respectively, to zero, and decreasing first and second power references of the first LCC and the second LCC, respectively, to zero, increasing power flow via the first VSC and the second VSC to maximum power flow in a power flow direction of the power flow deviation, disconnecting the first LCC and the second LCC from the HVDC transmission system, reversing voltage polarity of each of the first LCC and the second LCC, reconnecting the first LCC and the second LCC to the HVDC transmission system, and increasing the power reference of the first LCC and the second LCC after reconnecting the first LCC and the second LCC to the HVDC transmission system when the power support direction of the power order deviation is different from a power flow direction of the HVDC transmission system and the power order deviation is less than a sum of a total power change of the first VSC and the second VSC from the power reference of the VSC to reversed maximum power and a total power change of the first LCC and the second LCC from the power reference of the LCC to reversed maximum power.

In still further embodiments, controlling the first terminal and the second terminal comprises: configuring the second LCC in the constant DC voltage mode, configuring the second VSC in the constant active power mode, decreasing first and second power references of the first VSC and the second VSC, respectively, to zero, and decreasing first and second power references of the first LCC and the second LCC, respectively, to zero, increasing power flow via the first VSC and the second VSC to maximum power flow in a power flow direction of the power flow deviation, disconnecting the first LCC and the second LCC from the HVDC transmission system, reversing voltage polarity of each of the first LCC and the second LCC, reconnecting the first LCC and the second LCC to the HVDC transmission system, and increasing the power reference of the first LCC and the second LCC to maximum capacity or greater after reconnecting the first LCC and the second LCC to the HVDC transmission system when the power support direction of the power order deviation is different from a power flow direction of the HVDC transmission system and the power order deviation is not less than a sum of a total power change of the first VSC and the second VSC from the power reference of the VSC to reversed maximum power and a total power change of the first LCC and the second LCC from the power reference of the LCC to reversed maximum power.

Other systems, methods, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a diagram of three major power grid seams in the contiguous United States;

FIG. 2 is a block diagram of a power system distribution network including a station-hybrid high voltage direct current (HVDC) system for power transmission in accordance with some embodiments of the inventive concept;

FIG. 3 illustrates a data processing system that may be used to implement controller of FIG. 1 for managing a station-hybrid HVDC system in accordance with some embodiments of the inventive concept;

FIG. 4 is a block diagram that illustrates a software/hardware architecture for use in a controller for managing a station-hybrid HVDC system in accordance with some embodiments of the inventive concept;

FIGS. 5-7 are flowchart diagrams that illustrate operations of a station-hybrid HVDC system in accordance with some embodiments of the inventive concept;

FIG. 8 is a schematic of a station-hybrid HVDC system in accordance with some embodiments of the inventive concept;

FIG. 9 is a block diagram of the terminals used in a station-hybrid HVDC system in accordance with some embodiments of the inventive concept;

FIG. 10 is a schematic of a terminal used in a station-hybrid HVDC system in accordance with some embodiments of the inventive concept;

FIG. 11 is a schematic of a switching network used in a terminal of a station-hybrid HVDC system in accordance with some embodiments of the inventive concept;

FIG. 12 is a schematic of a station-hybrid HVDC system in various states for reversing power flow in accordance with some embodiments of the inventive concept.

FIG. 13 is a block diagram that illustrates generation of a power order deviation in response to a frequency disturbance in accordance with some embodiments of the inventive concept;

FIG. 14 is a listing of pseudocode that illustrates a control scheme methodology in providing emergency power support control in accordance with some embodiments of the inventive concept;

FIGS. 15A, 15B, 15C, and 15D are graphs that illustrate performance of a simulation of a station-hybrid HVDC system during power flow reversal in accordance with embodiments of the inventive concept;

FIGS. 16, 16B, 16C, and 16D are graphs that illustrate performance of a simulation of a station-hybrid HVDC system during emergency power support control in accordance with embodiments of the inventive concept;

FIG. 17 is a diagram of a model of the North American power grid for simulating use of a station-hybrid HVDC system in accordance with some embodiments of the inventive concept; and

FIGS. 18A, 18B, 18C, and 18D are graphs that illustrate performance of a simulation of a station-hybrid HVDC system used for cross-seam interconnection in a power grid in accordance with embodiments of the inventive concept.

### DETAILED DESCRIPTION

In the following detailed description, numerous specific details are set forth to provide a thorough understanding of embodiments of the present disclosure. However, it will be understood by those skilled in the art that the present invention may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As used herein, the term “data processing facility” includes, but it is not limited to, a hardware element, firmware component, and/or software component. A data processing system may be configured with one or more data processing facilities.

Some embodiments of the inventive concept may provide a hybrid high voltage direct current (HVDC) transmission system that can be used to provide cross-seam transmission including a reversal switch mechanism and a power flow reversal capability. Moreover, emergency power support control is provided for a variety of different emergency situations.

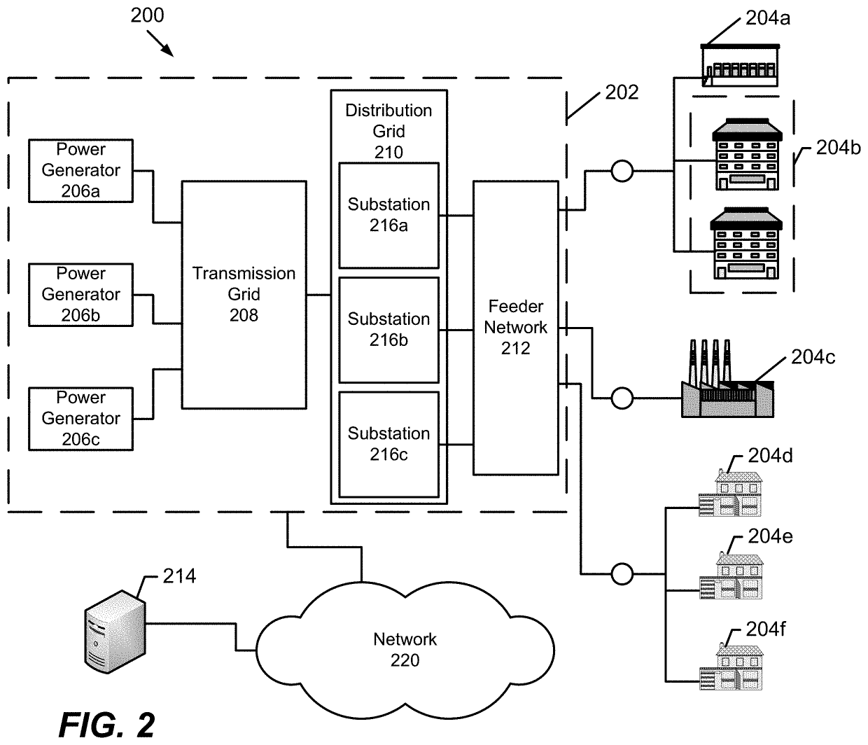

Referring to FIG. 2, a power system distribution network 100 that use a station-hybrid HVDC transmission system, in accordance with some embodiments of the inventive concept, comprises a main power grid 202, which is typically operated by a public or private utility, and which provides power to various power consumers 204a, 204b, 204c, 204d, 204e, and 204f. The electrical power generators 206a, 206b, and 206c are typically located near a fuel source, at a dam site, and/or at a site often remote from heavily populated areas. The power generators 206a, 206b, and 206c may be nuclear reactors, coal burning plants, hydroelectric plants, and/or other suitable facility for generating bulk electrical power. The power output from the power generators 206, 206b, and 206c is carried via a transmission grid 208 or transmission network over potentially long distances at relatively high voltage levels. The transmission grid may include a station-hybrid HVDC transmission system according to some embodiments of the inventive concept as described herein A distribution grid 210 may comprise multiple substations 216a, 216b, 216c, which receive the power from the transmission grid 208 and step the power down to a lower voltage level for further distribution. A feeder network 212 distributes the power from the distribution grid 210 substations 216a, 216b, 216c to the power consumers 204a, 204b, 204c, 204d, 204e, and 204f. The power substations 216a, 216b, 216c in the distribution grid 210 may step down the voltage level when providing the power to the power consumers 204a, 204b, 204c, 204d, 204e, and 204f through the feeder network 212.

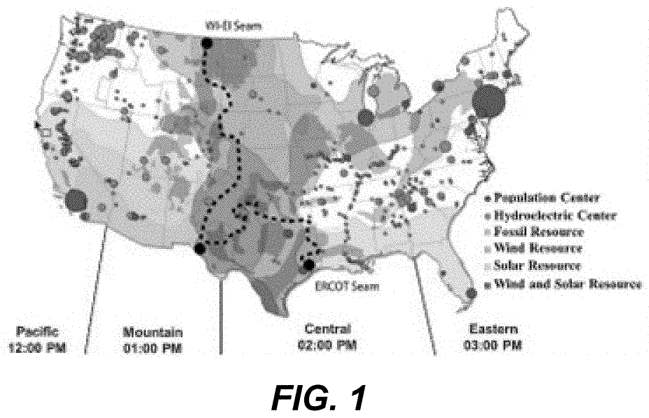

As shown in FIG. 1, the power consumers 204a, 204b, 204c, 204d, 204e, and 204f may include a variety of types of facilities including, but not limited to, a warehouse 204a, a multi-building office complex 204b, a factory 204c, and residential homes 204d, 204e, and 204f. A feeder circuit may connect a single facility to the main power grid 202 as in the case of the factory 204c or multiple facilities to the main power grid 202 as in the case of the warehouse 204a and office complex 204b and also residential homes 204d, 204e, and 204f. Although only six power consumers are shown in FIG. 2, it will be understood that a feeder network 112 may service hundreds or thousands of power consumers.

The power distribution network 200 further comprises a Distribution Management System (DMS) 214, which may monitor and control the generation and distribution of power via the main power grid 202. The DMS 214 may comprise a collection of processors and/or servers operating in various portions of the main power grid 202 to enable operating personnel to monitor and control the main power grid 202. The DMS 214 may further include other monitoring and/or management systems for use in supervising the main power grid 202. One such system is known as the Supervisory Control and Data Acquisition (SCADA) system, which is a control system architecture that uses computers, networked data communications, and graphical user interfaces for high-level process supervisory management of the main power grid. The network 220 may be a global network, such as the Internet or other publicly accessible network. Various elements of the network 220 may be interconnected by a wide area network, a local area network, an Intranet, and/or other private network, which may not be accessible by the general public. Thus, the communication network 220 may represent a combination of public and private networks or a virtual private network (VPN). The network 220 may be a wireless network, a wireline network, or may be a combination of both wireless and wireline networks.

Although FIG. 2 illustrates an example a power distribution network 200 including a station-hybrid HVDC transmission system, it will be understood that embodiments of the inventive concept are not limited to such configurations, but are intended to encompass any configuration capable of carrying out the operations described herein.

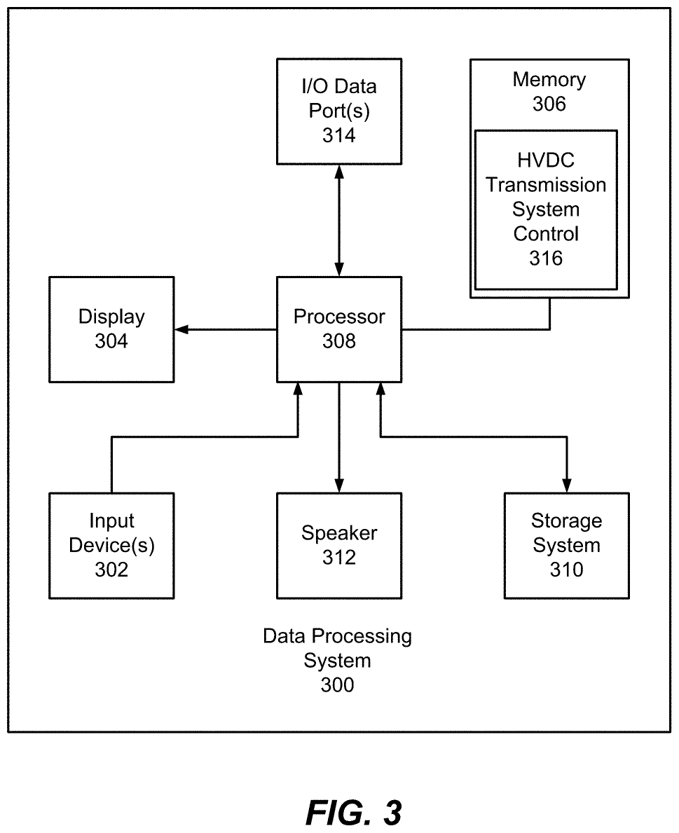

Referring now to FIG. 3, a data processing system 300 that may be used to implement the DMS 214 processor of FIG. 2, in accordance with some embodiments of the inventive concept, comprises input device(s) 302, such as a keyboard or keypad, a display 304, and a memory 306 that communicate with a processor 308. The data processing system 300 may further include a storage system 310, a speaker 312, and an input/output (I/O) data port(s) 314 that also communicate with the processor 308. The storage system 310 may include removable and/or fixed media, such as floppy disks, ZIP drives, hard disks, or the like, as well as virtual storage, such as a RAMDISK. The I/O data port(s) 314 may be used to transfer information between the data processing system 300 and another computer system or a network (e.g., the Internet). These components may be conventional components, such as those used in many conventional computing devices, and their functionality, with respect to conventional operations, is generally known to those skilled in the art. The memory 306 may be configured with HVDC transmission system control module 216 that may provide functionality that may include, but is not limited to, managing the operational mode of voltage source converters (VSCs) in the station-hybrid HVDC transmission system, managing the operational mode of line commutated converters (LCCs) in the station-hybrid HVDC transmission system, managing power reversal in the station-hybrid HVDC transmission system, and managing emerge power support in the station-hybrid HVDC transmission system.

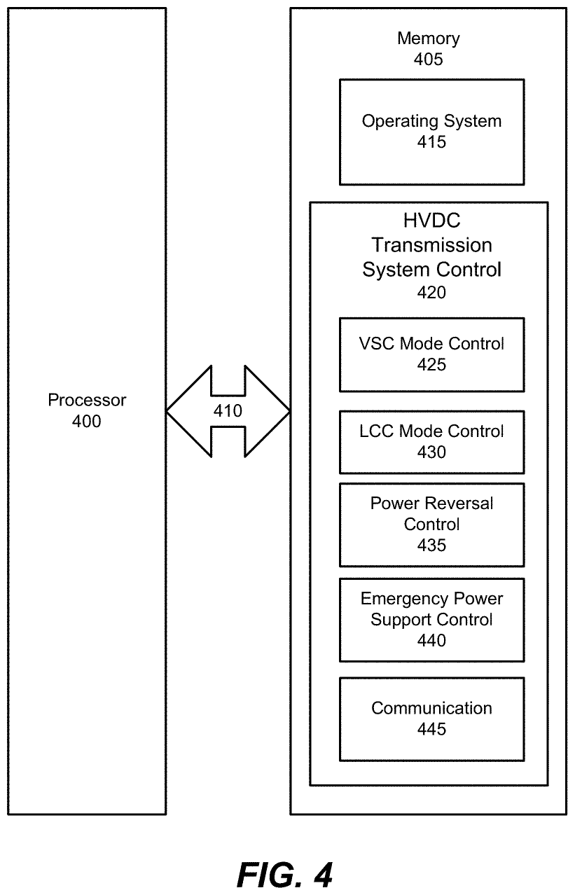

FIG. 4 illustrates a processor 400 and memory 405 that may be used in embodiments of data processing systems, such as the DMS 214 processor of FIG. 2 and the data processing system 300 of FIG. 3, respectively, for managing a station-hybrid HVDC transmission system, in accordance with some embodiments of the inventive concept. The processor 400 communicates with the memory 405 via an address/data bus 410. The processor 400 may be, for example, a commercially available or custom microprocessor. The memory 405 is representative of the one or more memory devices containing the software and data used for managing a station-hybrid HVDC transmission system in accordance with some embodiments of the inventive concept. The memory 405 may include, but is not limited to, the following types of devices: cache, ROM, PROM, EPROM, EEPROM, flash, SRAM, and DRAM.

As shown in FIG. 4, the memory 405 may contain two or more categories of software and/or data: an operating system 415 and a HVDC transmission system control module 420. In particular, the operating system 415 may manage the data processing system's software and/or hardware resources and may coordinate execution of programs by the processor 400. The HVDC transmission system control module 420 may comprise a VSC mode control module 425, an LSC mode control module 430, a power reversal control module 435, an emergency power support control module 440, and a communication module 445.

The VSC mode control module 425 may be configured to control the operating modes of VSCs in a multi-terminal station-hybrid HVDC transmission system according to some embodiments of the inventive concept. The LCC mode control module 430 may be configured to control the operating modes of LCCs in the multi-terminal station-hybrid HVDC transmission system according to some embodiments of the inventive concept. The power reversal control module 435 may be configured to the direction of power between the two terminals in a multi-terminal station-hybrid HVDC transmission system according to some embodiments of the inventive concept. The emergency power support control module 440 may be configured to control operation of the multi-terminal station-hybrid HVDC transmission system in response to detection of a system frequency disturbance including selection of various response schemes in accordance with some embodiments of the inventive concept. The communication module 455 may be configured to facilitate communication between the DMS 214 processor and the multi-terminal station-hybrid HVDC transmission system over the network 220

Although FIG. 4 illustrates hardware/software architectures that may be used in data processing systems, such as the DMS 214 processor of FIG. 2 and the data processing system 300 of FIG. 3, respectively, for controlling operation of a multi-terminal station-hybrid HVDC transmission system, in accordance with some embodiments of the inventive concept it will be understood that the present invention is not limited to such a configuration but is intended to encompass any configuration capable of carrying out operations described herein.

Computer program code for carrying out operations of data processing systems discussed above with respect to FIGS. 2-4 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the DMS 214 processor of FIG. 2, the data processing system 300 of FIG. 3, and the hardware/software architecture of FIG. 4, may each be implemented as a single processor system, a multi-processor system, a multi-core processor system, or even a network of stand-alone computer systems, in accordance with various embodiments of the inventive concept. Each of these processor/computer systems may be referred to as a “processor” or “data processing system.”

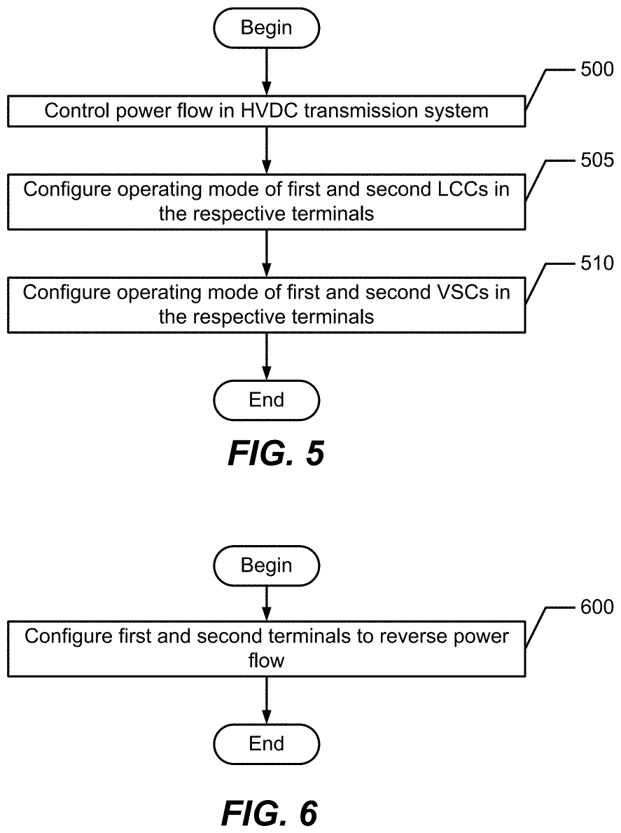

The data processing apparatus of FIGS. 2-4 may be used to facilitate the control of a multi-terminal station-hybrid HVDC transmission system, according to various embodiments described herein. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 306 coupled to the processor 308 and the memory 405 coupled to the processor 400 include computer readable program code that, when executed by the respective processors, causes the respective processors to perform operations including one or more of the operations described herein with respect to FIGS. 5-14.

FIG. 5 is a flowchart that illustrates operations for controlling operations of a multi-terminal station-hybrid HVDC transmission system according to some embodiments of the inventive concept. Operations begin at block 500 where the power flow is controlled in a multi-terminal station-hybrid HVDC transmission system that includes a first terminal with a first VSC and a first LCC and a second terminal with a second VSC and a second LCC. The first and second terminals are connected by a transmission line pair. At block 505, the operating mode of the first and second LCCs is configured in the respective terminals and at block 510 the operating mode of the first and second VSCs is controlled in the respective terminals. Thus, the control of the operating modes of the LCCs and the VSCs in the two different may allow the power flow to be directed in a first direction.

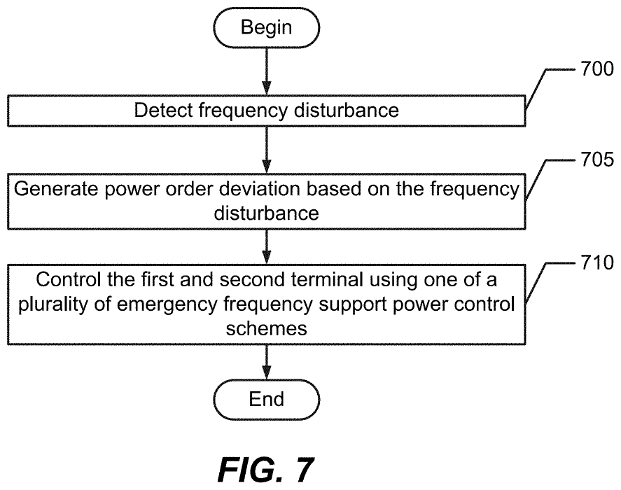

Referring now to FIG. 6, the power flow may be reversed through selective configuration of the LCCs and the VSCs in the first and second terminals at block 600. Moreover, in some embodiments, the multi-terminal station-hybrid HVDC transmission system may be used to provide an emergency response to a frequency deviation. Referring now to FIG. 7, operations begin at block 700 where a frequency disturbance is detected. A power order deviation may be generated based on the frequency disturbance at block 705. The first and second terminals may be controlled using one of a plurality of emergency frequency support power control schemes at block 710.

Embodiments of the inventive concept may be illustrated by way of example with respect to FIGS. 8-18A, 18B, 18C, and 18D.

FIG. 8 shows the configuration of a multi-terminal station-hybrid HVDC system according to some embodiments of the inventive concept. The multi-terminal station-hybrid HVDC system is a bipolar HVDC system. Each terminal is composed of one LCC and one VSC. The LCC and VSC are connected in parallel on the DC side and share the same transmission DC line. On the DC side of each LCC, a reversal switch mechanism is configured to change the voltage polarity for reversing power direction.

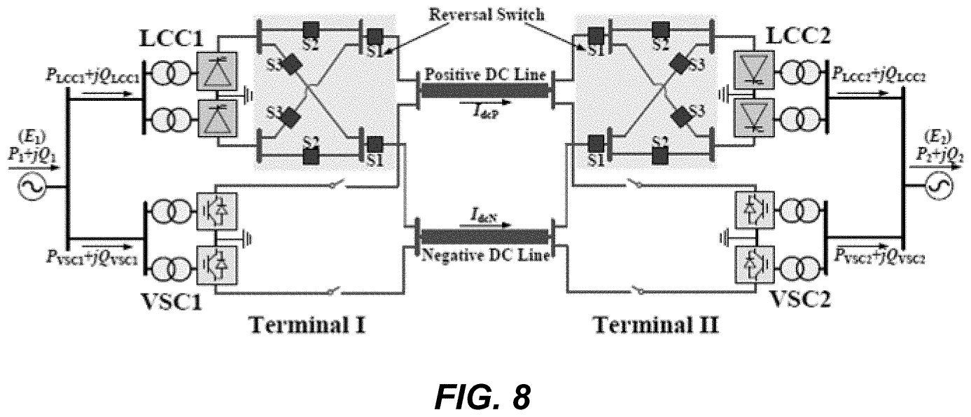

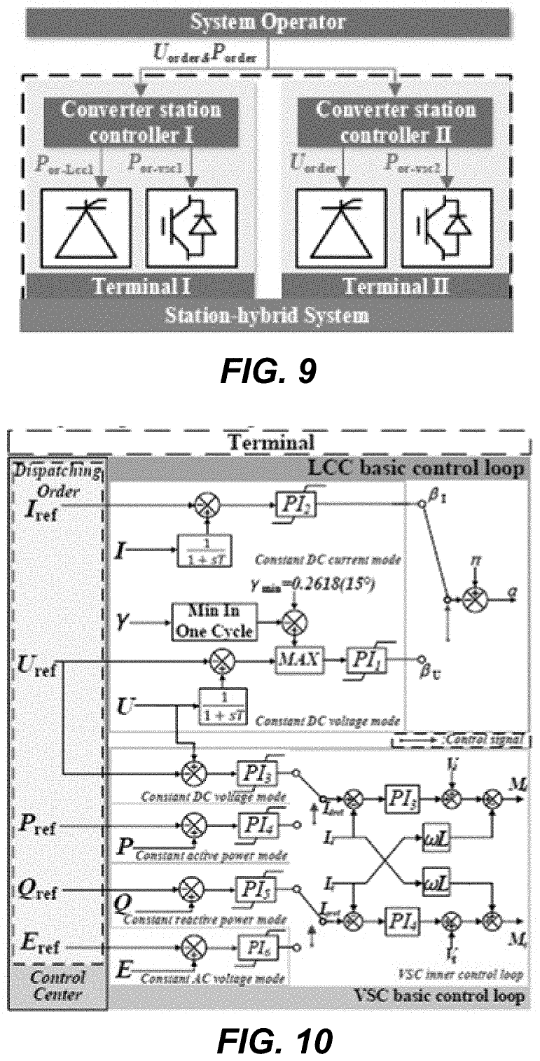

In the multi-terminal station-hybrid HVDC system, the capacity of the LCCs may be greater than the VSCs for reducing the investment cost. However, under most operation situations, the power flow on the multi-terminal station-hybrid HVDC system may not reach its maximum capacity. Considering the different operation requirements, the station controller may be configured in each terminal for power distribution control and optimization between the LCC and VSC. FIG. 9 shows the control structure of the multi-terminal station-hybrid HVDC system, where Porder is the power reference of station-hybrid system, P_{or-LCC1} is the power reference of the LCC in the terminal I, P_{or-VSC1} is the power reference of the VSC in the terminal I, P_{or-VSC2} is the power reference of the VSC in the terminal II and P_{LCC2} is power flow through the LCC in the terminal II.

In the normal operation, one terminal of the station-hybrid system controls the DC voltage and the other terminal controls the power flow. At each terminal, the LCCs and VSCs are controlled independently by the converter station controller. The system operator sends the DC voltage control order to one terminal to set the DC operating voltage of station-hybrid system (in this example, the DC voltage control order is sent to the LCC converter in the terminal II) and sends the power control order to the converter station controllers of both terminals to control the power flow. In the terminal, the power control order is distributed by the converter station controller to the LCC and the VSC according to the appropriate power distribution strategy. One distribution strategy may allocate the power order to the LCC and the VSC according to their capacity ratio. In other embodiments, a strategy may be to maximize the LCC capacity utilization for bulk power transmission while using the VSC capacity for flexible power flow regulation. For example, if the scheduled power of the station-hybrid system is less than the capacity of LCCs, the power only flows through the LCCs; and if the scheduled power is over the capacity of LCCs, the LCCs would operate at full capacity. This normal operation strategy may reduce converter station losses and reserve VSC capacity to provide flexible power regulation and reactive power support to AC grids.

The basic control of the VSC and LCC in one terminal is shown in FIG. 10, where I and I_{ref} are the measured and reference DC currents, U and U_{ref} are the measured and reference DC voltage, P and P_{ref} are measured and reference active power, Q and Q_{ref} are measured and reference reactive power, E and E_{ref} are the measured and reference AC voltage.

As shown in FIG. 10, the LCC and VSC may be controlled independently with each of the LCC and VSC including a plurality of proportional-integral (PI) controllers. The LCC may be controlled in the constant DC voltage mode with standby constant extinction angle control or constant DC current mode, and the VSC may be controlled in the constant DC voltage mode or constant active power mode. For meeting different control objectives, the LCC and VSC may work together as an inverter or rectifier with corresponding control strategies.

One feature of the multi-terminal station-hybrid HVDC system, according to some embodiments of the inventive concept, is the capability for uninterrupted power flow reversal. In North America, load diversity between regions contributes a significant portion of the total economic benefits of the cross-seam interconnections. However, due to the time zone differences, it may require multiple instances of uninterrupted power flow reversal in a single day. Existing hybrid HVDC configurations and corresponding power reversal methods need to change the voltage polarity of DC lines, which takes tens of seconds up to a few minutes for line discharging. During this time, the station-hybrid system is in a shutdown state, and power transmission is interrupted. Such a drawback makes them unsuitable for cross-seam interconnections.

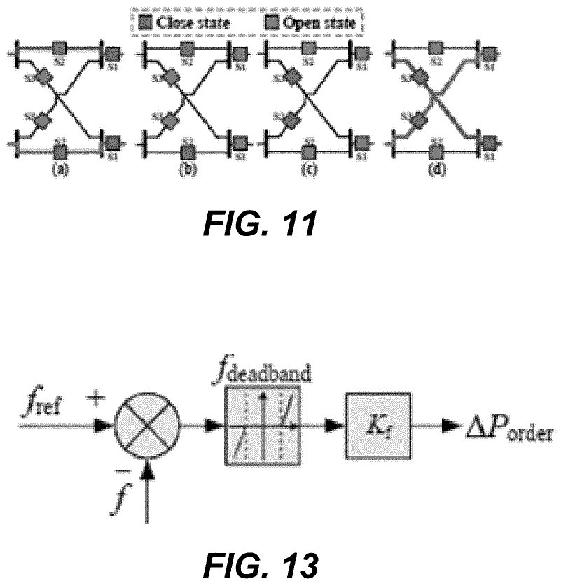

The multi-terminal station-hybrid HVDC system, according to some embodiments of the inventive concept, may realize uninterrupted power flow reversal, the DC lines do not need to reverse voltage polarity, and no power interruption need occur. For achieving the uninterrupted bidirectional power flow transmission, a reversal switch mechanism and a power flow reversal control may be used in the multi-terminal station-hybrid HVDC system. The topology and operation principle of the reversal switch mechanism are shown in FIG. 11.

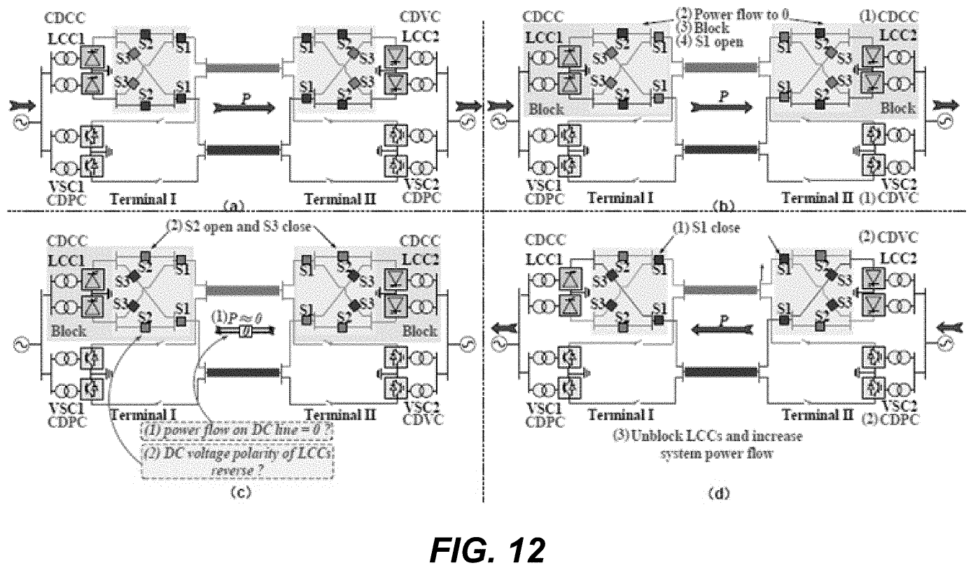

The mechanical switches or disconnectors used in the example reversal switch mechanism are designed to close and open very rapidly. In addition, the mechanical switches may also have to commutate load current while maintaining the flow of power within the DC substation and its availability. The reversal switch mechanism is configured on the DC side of each LCC, which contains three groups of mechanical switches. For normal operation, the S₁ and S₂ are closed, and the current flows through S₁ and S₂, as shown in FIG. 11 example (a). When the LCC needs to reverse its voltage polarity, first, the switch S₁ opens to disconnect the LCC from the station-hybrid system, as shown in FIG. 11, example (b). Then, the switch S₂ opens and the switch S₃ closes, as shown in FIG. 11 example (c). Finally, as shown in FIG. 11 example (d), the switch S₁ closes and the current flow is changed from flowing through switches S₁ and S₂ to flowing through switches S₁ and S₃, which results in the voltage polarity of the LCC being changed. The example power flow reversal control is for the scheduled power flow reversal of the multi-terminal station-hybrid HVDC system according to some embodiments of the inventive concept. The control strategy of the power flow reversal control is shown in FIG. 12 and Table I.

TABLE I
POWER FLOW REVERSAL CONTROL STRATEGY

| Control Step | | |
|---|---|---|
| Normal | (1) | Control: |
| Operation | | LCC1: Constant DC current control (CDCC) |
| | | LCC2: Constant DC voltage control (CDVC) |
| | | VSC1: Constant DC power control (CDPC) |
| | | VSC2: Constant DC power control |
| | (2) | The dispatch power flow direction is from Terminal |
| | | I to Terminal II. |
| Power Flow | (1) | LCC2 changes to CDCC while VSC2 changes to |
| Reversal | | CDVC |
| Control | (2) | Decrease the active power of LCC1 and LCC2 to 0 |
| (Step I) | | with a constant ramping rate |
| | (3) | Block LCC1 and LCC2 |
| | (4) | Disconnect LCC1 and LCC2 from the system by |
| | | opening the S1 |
| Power Flow | (1) | Decrease the power flow on the DC line to 0 by |
| Reversal | | adjusting VSC1 reference |
| Control | (2) | Reverse voltage polarity of LCCs by closing S2 and |
| (Step II) | | opening S3 |
| | Determine statements: | |
| | (1) | Power flow on DC line = 0? |
| | (2) | DC voltage polarity of LCCs reverse? |
| Power Flow | (1) | Reconnect LCC1 and LCC2 to the system by closing |
| Reversal | | the S1 |
| Control | (2) | LCC2 changes to CDVC while VSC2 changes to |
| (Step III) | | CDPC |
| | (3) | Unblock the LCCs, Increase the active power of |
| | | LCC1 and VSCs. |

With the example reversal switch mechanism and the example power flow reversal control, the multi-terminal station-hybrid HVDC system may reverse the power flow smoothly without any power interruption. In addition, for reducing the construction cost in multi-terminal station-hybrid HVDC system according to some embodiments of the inventive concept, the capacity of the LCC may be several times of the capacity of the VSC. The LCC may be used for bulk power transmission, and the VSC may be primarily used for power regulation and reactive power compensation. Therefore, the multi-terminal station-hybrid HVDC system, according to some embodiments of the inventive concept, may be a low-cost solution and may be particularly suited for the cross-seam interconnections.

Besides realizing the uninterrupted bidirectional power flow transmission under normal operating conditions, the multi-terminal station-hybrid HVDC system may also provide fast and controllable power support between interconnections under emergency conditions. The emergency condition may be caused by large generation trips or critical transmission line tripping. The frequency response reserves sharing across interconnections is another potential application of the multi-terminal station-hybrid HVDC system. Frequency response control of the cross-seam HVDC link can be designed to emulate synchronous generators. With coordinated control between the LCC and VSC in stations of the multi-terminal station-hybrid HVDC system, if necessary, the power flow on the hybrid system may be reversed immediately.

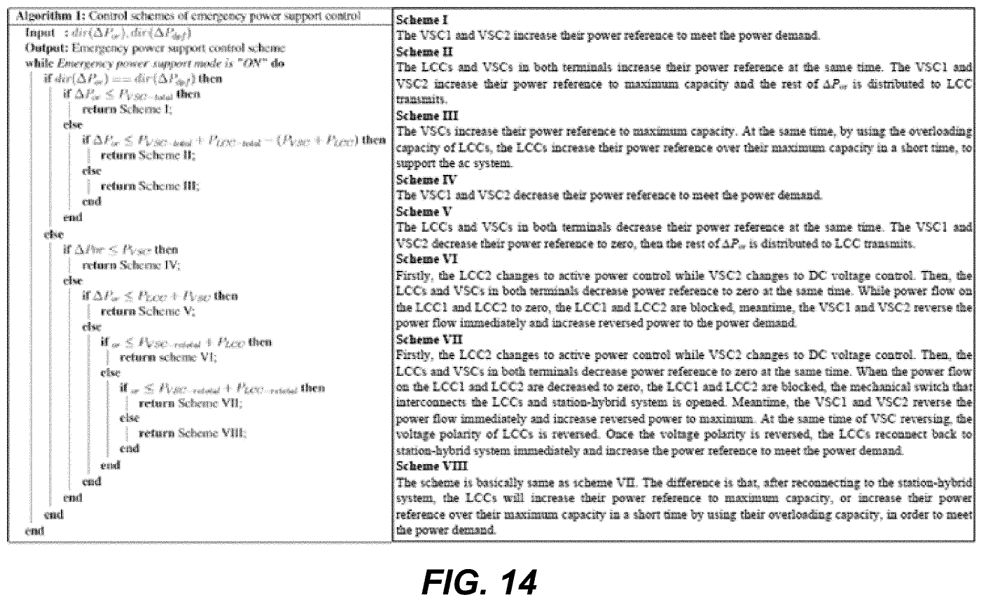

An emergency power support control methodology using the multi-terminal station-hybrid HVDC system, according to some embodiments of the inventive concept, may provide effective control schemes for meeting different emergency support situations. The emergency power support control is based on frequency-active power droop control (FPDC). The control diagram of the FPDC is shown in FIG. 13. Upon the detection of a system frequency disturbance (when the frequency is outside a predefined dead band), the frequency deviation is translated to power order deviation ΔP or through FPDC. Then, a suitable emergency power control scheme is activated to provide frequency support to the disturbed AC system. The selection of the emergency power support control schemes is determined by the original power order of the station-hybrid system, the power flow direction, and the value of ΔP or. According to the different system operating conditions and disturbances, eight control schemes may be used for emergency power support control, according to different embodiments of the inventive concept, as shown in the pseudocode of FIG. 14. The abbreviations in FIG. 14 are listed in Table II.

TABLE II
ABBREVIATIONS OF EMERGENCY
POWER SUPPORT CONTROL

| abbreviations | definitions |
|---|---|
| dir(ΔPₒᵣ) | The power flow direction of ΔPₒᵣ |
| dir(ΔP_{dpf}) | The power flow direction of ΔP_{dpf} |
| Pₒᵣ | Power order from the dispatch center |
| P_{VSC} | Power reference of VSC |
| P_{LCC} | Power reference of LCC |
| P_{VSC-retotal} | Total power change of VSC from the power reference |
| | to reversed maximum power |
| P_{LCC-retotal} | Total power change of LCC from the power reference |
| | to reversed maximum power |
| P_{LCC-overload} | The overload capacity of the LCC |

To validate the performance of the multi-terminal station-hybrid HVDC system, according to some embodiments of the inventive concept, a two-terminal hybrid HVDC transmission test system, as shown in FIG. 8, is implemented in PSCAD/EMTDC. The main circuit parameters and the initial system setup of the test system are listed in Table III and Table IV.

TABLE III
MAIN CIRCUIT PARAMETERS

| | Terminal I | | Terminal II | |
|---|---|---|---|---|
| | LCC1 | VSC1 | LCC2 | VSC2 |
| Rated AC voltage (kV) | 500 | | 500 | |
| Rated DC voltage (kV) | ±500 | | | |
| Rated DC current (kA) | 3 | 1 | 3 | 1 |
| Rated power (MW) | 4000 | | 4000 | |
| | 3000 | 1000 | 3000 | 1000 |

| | |
|---|---|
| DC Line length (km) | 1000 |

TABLE IV
INITIAL SYSTEM SETUP

| | Terminal I | | Terminal II | |
|---|---|---|---|---|
| | LCC1 | VSC1 | LCC2 | VSC2 |
| Power flow direction | Terminal I to Terminal II | | | |
| Control mode | Constant | Constant | Constant | Constant |
| | DC | DC | DC | DC |
| | current | power | voltage | power |
| | control | control | control | control |
| Reference DC | | | 460 | |
| voltage (kV) | | | | |

* The reference DC voltage of LCC2 is set as 460 kV so that the DC voltage of LCC1 is 500 kV (1 pm).

In the following, the effectiveness of the power flow reversal control and emergency power support control are verified by simulation results. Corresponding results and analysis are given in the following description.

The power flow reversal verification scenario is implemented to verify the feasibility of the uninterrupted power flow reversal of the multi-terminal station-hybrid HVDC system, according to some embodiments of the inventive concept. The initial condition of the hybrid HVDC system is as follows: Before t=6.0 s, the multi-terminal station-hybrid HVDC system has transitioned into normal operation mode. The system transmits the scheduled 4000 MW power from Terminal I to Terminal II. At t=6.0 s, the system operates under power flow reversal control. Under normal operation, the power regulation of the HVDC transmission system is slow—up to 100 MW per minute. For shortening the simulation process, in the simulation, the power ramping rate is set to 500 MW/s.

Following the sequence of operation is executed to evaluate the proposed power flow reversal control:

At t=6.0 s, the control mode of LCC2 changes to constant DC current control to control the power flow, and the control mode of VSC2 changes to constant DC voltage control to maintain the DC voltage of the system.

At 6.0 s˜12.0 s, the reference DC currents of LCC1 and LCC2 are decreased to 0 with constant power ramping rate.

At t=12.0 s, the LCC1 and LCC2 are blocked, and the mechanical switches are opened.

At 12.0 s˜14.0 s, the voltage polarity of LCC1 and LCC2 are reversed by the reversal switch mechanism. Concurrently, the active power reference of VSC1 is adjusted from 1000 MW to 0 MW linearly.

At t=14.5 s, the reference DC voltage of VSC2 is set to 500 kV due to VSC2 working as a rectifier now.

At t=15.0 s, the mechanical switches are closed, and LCC1 and LCC2 are unblocked. The control mode of LCC2 changes to constant DC voltage control, and the control mode of VSC2 changes to constant active power control.

At 15.0 s˜26.0 s, the reference active power of LCC1 is changed to −3000 MW linearly. The reference active power of VSC1 is adjusted from 0 MW to −1000 MW.

At 26.0 s˜28.0 s, the reference active power of VSC2 is adjusted from 0 MW to 1000 MW.

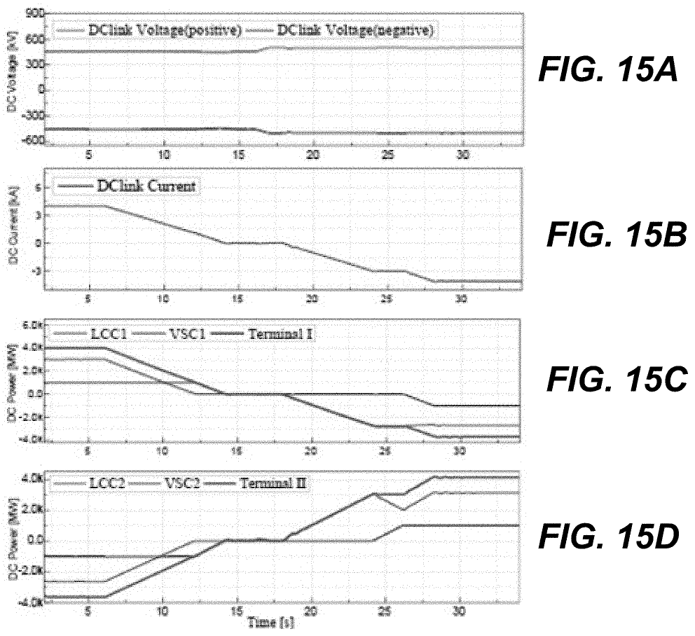

FIGS. 15A-15D show the station-hybrid system performance during normal power flow reversal. As can be seen in FIGS. 15A-15D, the DC voltage of the multi-terminal station-hybrid HVDC system, according to some embodiments of the inventive concept, remains stable during the power flow reversal process (from 6.0 s to 28.0 s). This means that the two terminals of the station-hybrid system keep working during this period, while the DC voltage is continuously controlled by one of the terminals. In addition, the power rise and fall are smooth with small fluctuation during the power flow reversal (as shown in FIGS. 15A-15D, 15.0 s˜26.0 s). This means that the operation of the multi-terminal station-hybrid HVDC system, according to some embodiments of the inventive concept, under the power flow reversal process meets general reliability requirements for HVDC transmission systems. From the simulation results, it can be seen that, with the example power flow reversal control methodology, the multi-terminal station-hybrid HVDC system, according to some embodiments of the inventive concept, may achieve bidirectional power flow transmission. The power flow reversal is a s smooth as normal dispatching. Moreover, there is no need to stop the system operation for the power flow reversal process.

Emergency grid support capability verification scenarios a r e implemented to verify the grid support capability of the multi-terminal station-hybrid HVDC system, according to some embodiments of the inventive concept, under different emergency operating conditions. The initial condition of the station-hybrid HVDC system is as follows: Before t=2.5 s, the station-hybrid system transmits the scheduled 3500 MW power from Terminal I to Terminal II. At t=2.5 s, a power plant is tripped in the AC system, and the multi-terminal station-hybrid HVDC system, according to some embodiments of the inventive concept, works in emergency power support control, the disturbed system needs 800 MW power support from other systems, the power flow direction is the same as the power flow of the station-hybrid system. At t=4.0 s, the other side of the AC system needs 5100 MW power support. At t=6.5 s, the power demand of emergency support is increased to 7000 MW. Under emergency operation, the power regulation of the multi-terminal station-hybrid HVDC system could be up to 200 MW per second. For shortening the simulation process the power ramping rate is set to 2000 MW/s in the simulation.

The following sequence of operations are executed with controls to evaluate the grid support capability of the multi-terminal station-hybrid HVDC system, according to some embodiments of the inventive concept, and to verify all the example control schemes proposed in the emergency power support control:

At t=2.5 s, the power support direction is the same as the power flow of the station-hybrid system, and the power support demand is larger than the sum of the rest capacity of LCC and VSC. Therefore, the control scheme III of emergency power support control is selected.

At 2.5 s˜2.75 s, the VSC1, and VSC2 increase their power reference from 500 MW to 1000 MW (maximum power), and the LCC1 increases its power reference from 3000 MW to 3300 MW through its overloading capacity.

At t=4.0 s, the power support direction is different from the power flow of the station-hybrid system. In addition, the power support demand is larger than the sum of the power reference of VSC and LCC, but the power support demand is smaller than the sum of the total power change of VSC from the power reference to reversed maximum power and the power reference of the LCC, therefore, the control scheme VI of emergency power support control is selected. The control mode of LCC2 changes to constant DC current control to control the power flow, and the control mode of VSC2 changes to constant DC voltage control to maintain the DC voltage of the system.

At 4.0 s˜5.65 s, the VSC1 decreases power reference from 1000 MW to zero linearly. In addition, the LCC1 decreases its power reference from 3300 MW to 0 value linearly.

At 5.65 s˜6.05 s, while the power flow on the LCC1 decreases to the 0 value, the LCC1 and LCC2 are blocked, and the mechanical switches are opened. At the same time, the power flow of VSCs reverses immediately, and the power reference of the VSC1 decreases to −800 MW. The reference DC voltage of VSC2 is set to 500 kV due to VSC2 now working as a rectifier.

At t=6.5 s, the power support direction is different from the power flow of the multi-terminal station-hybrid HVDC system. In addition, the power support demand is larger than the sum of the total power change of VSC from the power reference to reversed maximum power and the power reference of LCC, but the power support demand is smaller than the sum of the total power change of VSC from the power reference to reversed maximum power and total power change of LCC from the power reference to reversed maximum power. Therefore, the control scheme VII of emergency power support control is selected.

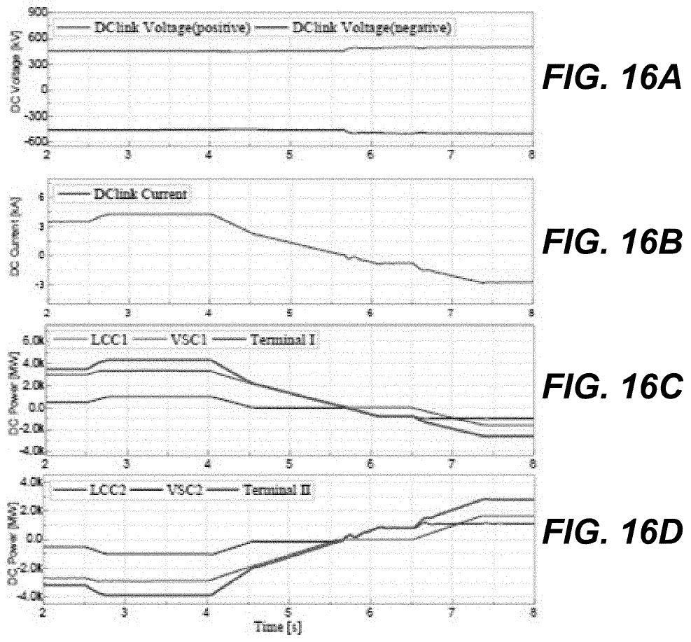

At 6.5 s˜7.35 s, the voltage polarity of LCC1 and LCC2 are reversed by the reversal switch mechanism. Then, the mechanical switches are closed immediately, and LCC1 and LCC2 are unblocked, the reference active power of LCC1 is changed to −1700 MW linearly. Concurrently, the active power reference of VSC1 is adjusted from −800 MW to −1000 MW linearly. FIGS. 16A-16D show the multi-terminal station-hybrid HVDC system, according to some embodiments of the inventive concept, performance during power support conditions. As can be seen, the station-hybrid system may reverse its power flow in seconds to provide emergency power for the disturbed system (as shown in FIGS. 16A-16D, 4.5 s˜6.5 s). Moreover, the DC voltage of the multi-terminal station-hybrid HVDC system, according to some embodiments of the inventive concept, remains stable during the emergency power support process. This means that the two terminals of the station-hybrid system keep working while one of the terminals may continuously control the DC voltage under fast power dispatching. In addition, the power flow adjusting of the multi-terminal station-hybrid HVDC system is generally very flexible because of coordinating control between the LCCs and VSCs in the two terminals. From the simulation results, it can be seen that, with the example emergency power support control methodology, the multi-terminal station-hybrid HVDC system, according to some embodiments of the inventive concept, may achieve relatively fast, uninterrupted bidirectional power flow dispatching for meeting different emergency conditions. In the safety operation premise of the multi-terminal station-hybrid HVDC system, it may significantly improve the reliability of the interconnected AC system.

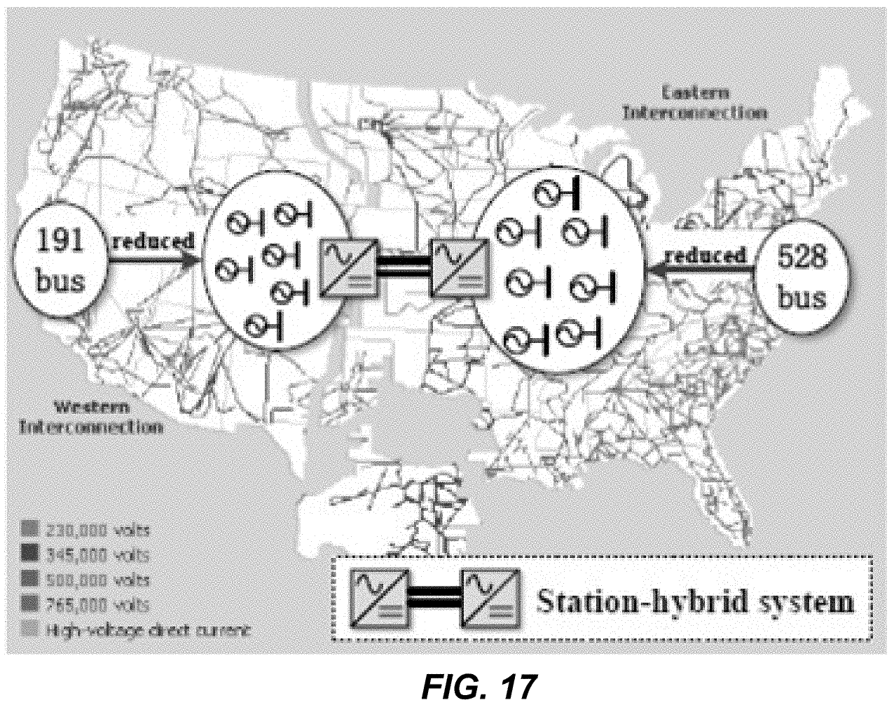

To verify the frequency response performance of the example multi-terminal station-hybrid HVDC system, an integrated North American power system model was developed in PSCAD simulation software by combining the highly reduced models of EI, WECC, and ERCOT, using a three-terminal VSC-MTDC system among the interconnections, as shown in FIG. 17.

The highly reduced models of EI and WECC are developed based on a reduced equivalent system as shown in FIG. 17. The data of the reduced equivalent system is taken from published public data. In the reduced equivalent system, there are 528 buses in the EI system and 191 buses in the WECC system. This reduced equivalent system has been verified with the full system models, particularly from the frequency response perspective. For realizing the effective PSCAD modeling, with the generation aggregation of a reduced equivalent system, the highly reduced models of EI and WECC are represented by 7 and 6 dynamic cluster generations. The dynamic cluster generation capacity of the highly reduced models is shown in Table V. The parameters of the FPDC configured in the multi-terminal station-hybrid HVDC system, including control gains and dead-bands are shown in Table VI.

TABLE V
THE DYNAMIC CLUSTER GENERATION CAPACITY
OF THE HIGHLY REDUCE MODELS

| | |
|---|---|
| EI | WECC |

| | Capacity | | Capacity |
|---|---|---|---|
| Gen | (MW) | Gen | (MW) |
| G-EI1 | 102410 | G-WE1 | 11350 |
| G-EI2 | 104593 | G-WE2 | 12875 |
| G-EI3 | 115006 | G-WE3 | 10713 |
| G-EI4 | 116854 | G-WE4 | 11682 |
| G-EI5 | 107176 | G-WE5 | 12685 |
| G-EI6 | 36809 | G-WE6 | 2640 |
| G-EI7 | 23603 | | |

TABLE VI
PARAMETERS OF THE FPDC CONTROLER

| | | |
|---|---|---|
| Station-hybrid system | Control gain | Dead-band (Hz) |

| | | | |
|---|---|---|---|
| WECC | WECC | 10000 | 0.02 |
| to EI | EI | 10000 | 0.02 |

The initial conditions of the multi-terminal station-hybrid HVDC system are as follows: before t=5 s, the multi-terminal station-hybrid HVDC system transmits the scheduled 600 MW power from WECC to EI. At t=5 s, the generator G-WE6 (2640 MW) is tripped in the WECC.

When the frequency of WECC crosses the dead-band of the FPDC control, the reference DC currents of LCC1 is decreased while the reference DC currents of VSC1 and VSC2 are reversal increased following the frequency deviation. When the power flow through the LCC decreases to 0, the control mode of VSC2 changes to constant DC voltage control to maintain the DC voltage of the system. Then, the power flow through VSCs is following the frequency change to provide support to the WECC system. After that, the multi-terminal station-hybrid HVDC system continuously provides frequency support until the system reaches a new steady-state.

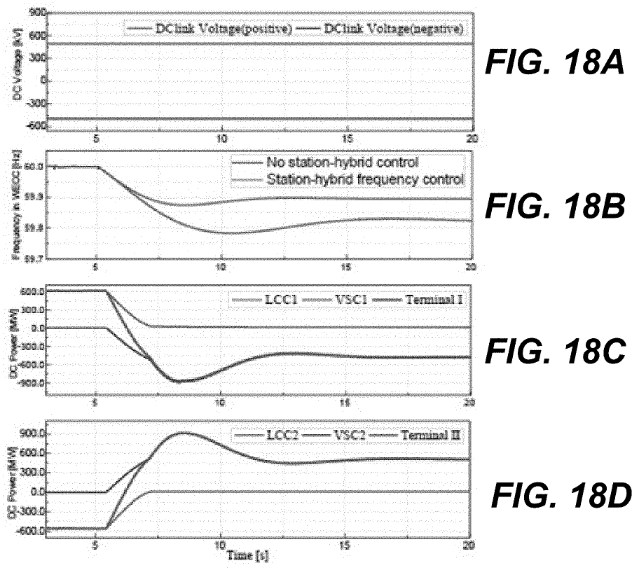

FIGS. 18A-18D show the multi-terminal station-hybrid HVDC system performance when providing system frequency support. As can be seen in FIGS. 18A-18D, when a generation trip event occurs and the frequency drop of the WECC system is over the dead-band of the FPDC control, the multi-terminal station-hybrid HVDC system may reverse its power flow in seconds to provide emergency power for the WECC. It may be seen from the simulation result that, with the emergency power support from the multi-terminal station-hybrid HVDC system, the frequency nadir of the WECC system after a generator trip is significantly improved, which indicates the multi-terminal station-hybrid HVDC system may enhance the system security against the frequency event.

Embodiments of the inventive concept may provide a multi-terminal station-hybrid HVDC system that can be used to stich seams in the North American power grid, for example. The multi-terminal station-hybrid HVDC system may include a parallel LSC and VSC configuration in each termination station, which may provide bidirectional bulk power transmission across interconnections. A reversal switch mechanism and a power slow reversal methodology may provide uninterrupted bidirectional power flow transmission under normal operating conditions. An emergency power support control methodology is provided, which, according to some embodiments of the inventive concept, includes eight different control schemes for different emergency conditions.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A high voltage direct current (HVDC) transmission system, comprising:
a first terminal comprising a first voltage source converter (VSC) having a first and second VSC terminals and a first line commutated converter (LCC) having first and second LCC terminals;
a second terminal comprising a second VSC having third and fourth VSC terminals and a second LCC having third and fourth LCC terminals; and
a transmission line pair comprising a positive transmission line that couples the first VSC terminal and the first LCC terminal of the first VSC and the first LCC, respectively, to the third VSC terminal and the third LCC terminal of the second VSC and the second LCC, respectively, and a second positive line that couples the second VSC terminal and the second LCC terminal of the first VSC and the first LCC, respectively, to the fourth VSC terminal and the fourth LCC terminal of the second VSC and the second LCC, respectively.

2. The HVDC transmission system of claim 1, wherein each of the first LCC and the second LCC are configured to operate in any of a plurality of LCC operating modes, the plurality of LCC operating modes comprising a constant DC current mode and a constant DC voltage mode; and
wherein each of the first VSC and the second VSC are configured to operate in any of a plurality of VSC operating modes, the plurality of VSC operating modes comprising a constant DC voltage mode, a constant active power mode, a constant reactive power mode, and a constant alternating current (AC) voltage mode.

3. The HVDC transmission system of claim 2, wherein the first terminal and the second terminal are configured to reverse a first power flow direction from the first terminal to the second terminal to a second power flow direction from the second terminal to the first terminal.

4. A method, comprising:
controlling power flow in a high voltage direct current (HVDC) transmission system on a transmission line pair between a first terminal and a second terminal, the first terminal comprising a first voltage source converter (VSC) having a first and second VSC terminals and a first line commutated converter (LCC) having first and second LCC terminals, the second terminal comprising a second VSC having third and fourth VSC terminals and a second LCC having third and fourth LCC terminals, and the transmission line pair comprising a positive transmission line that couples the first VSC terminal and the first LCC terminal of the first VSC and the first LCC, respectively, to the third VSC terminal and the third LCC terminal of the second VSC and the second LCC, respectively, and a second positive line that couples the second VSC terminal and the second LCC terminal of the first VSC and the first LCC, respectively, to the fourth VSC terminal and the fourth LCC terminal of the second VSC and the second LCC, respectively;
configuring each of the first LCC and the second LCC to operate in any of a plurality of LCC operating modes, the plurality of LCC operating modes comprising a constant DC current mode and a constant DC voltage mode; and
configuring each of the first VSC and the second VSC to operate in any of a plurality of VSC operating modes, the plurality of VSC operating modes comprising a constant DC voltage mode, a constant active power mode, a constant reactive power mode, and a constant alternating current (AC) voltage mode.

5. The method of claim 4, further comprising:
configuring the first terminal and the second terminal in a first power flow direction from the first terminal to the second terminal.

6. The method of claim 5, wherein configuring the first terminal and the second terminal in the first power flow direction, comprises:
configuring the first LCC in the constant DC current mode;
configuring the second LCC in the constant DC voltage mode;
configuring the first VSC in the constant active power mode; and
configuring the second VSC in the constant active power mode.

7. The method of claim 6, further comprising:
configuring the first terminal and the second terminal in a second power flow direction from the second terminal to the first terminal.

8. The method of claim 7, wherein configuring the first terminal and the second terminal in the second power flow direction comprises:
configuring the second LCC in the constant DC current mode;
decreasing active power of the first LCC and the second LCC to zero; and
disconnecting the first LCC and the second LCC from the HVDC transmission system.

9. The method of claim 8, wherein decreasing the active power of the first LCC and the second LCC to zero comprises decreasing the active power of the first LCC and the second LCC to zero using a constant ramping rate.

10. The method of claim 8, wherein configuring the first terminal and the second terminal in the second power flow direction further comprises:
decreasing power flow on the transmission line pair to zero; and
reversing voltage polarity of each of the first LCC and the second LCC.

11. The method of claim 10, wherein decreasing the power flow on the transmission line pair to zero comprises adjusting a reference voltage of the first VSC.

12. The method of claim 10, wherein configuring the first terminal and the second terminal in the second power flow direction further comprises:
reconnecting the first LCC and the second LCC to the HVDC transmission system;
configuring the second LCC in the constant DC voltage mode;
configuring the second VSC in the constant active power mode;
increasing the active power of the first LSC; and
increasing active power of the first VSC and the second VSC.

13. The method of 4, further comprising:
detecting a frequency disturbance in the high voltage direct current (HVDC) transmission system;
generating a power order deviation based on the frequency disturbance;
controlling the first terminal and the second terminal using one of a plurality of emergency frequency support power control schemes.

14. The method of claim 13, wherein controlling the first terminal and the second terminal comprises:
increasing first and second power references of the first VSC and the second VSC, respectively, when a power support direction of the power order deviation is a same as a power flow direction of the HVDC transmission system and the power order deviation is less than a combined maximum power output of the first VSC and the second VSC.

15. The method of claim 13, wherein controlling the first terminal and the second terminal comprises:
increasing first and second power references of the first VSC and the second VSC to maximum power capacity, respectively, and increasing first and second power references of the first LCC and the second LCC, respectively, when the when a power support direction of the power order deviation is a same as a power flow direction of the HVDC transmission system and the power order deviation is less than a difference between a first sum of the maximum power capacities of the first VSC and the second VSC, respectively, and maximum power capacities of the first LCC and the second LCC, respectively, and a second sum of the first and second power references of the first VSC and the second VSC, respectively, and the first and second power references of the first LCC and the second LCC, respectively.

16. The method of claim 13, wherein controlling the first terminal and the second terminal comprises:
increasing first and second power references of the first VSC and the second VSC to maximum power capacity, respectively, and increasing first and second power references of the first LCC and the second LCC to greater than maximum capacity, respectively, when the when a power support direction of the power order deviation is a same as a power flow direction of the HVDC transmission system and the power order deviation is not less than a difference between a first sum of the maximum power capacities of the first VSC and the second VSC, respectively, and the maximum power capacities of the first LCC and the second LCC, respectively, and a second sum of the first and second power references of the first VSC and the second VSC, respectively, and the first and second power references of the first LCC and the second LCC, respectively.

17. The method of claim 13, wherein controlling the first terminal and the second terminal comprises:
decreasing first and second power references of the first VSC and the second VSC, respectively, when a power support direction of the power order deviation is different from a power flow direction of the HVDC transmission system and the power order deviation is less than a power reference of the first VSC and the second VSC.

18. The method of claim 13, wherein controlling the first terminal and the second terminal comprises:
decreasing first and second power references of the first VSC and the second VSC, respectively, and decreasing first and second power references of the first LCC and the second LCC, respectively, when a power support direction of the power order deviation is different from a power flow direction of the HVDC transmission system and the power order deviation is less than a sum of a power reference of the first LCC and the second LCC and a power reference of the first VSC and the second VSC.

19. The method of claim 13, wherein controlling the first terminal and the second terminal comprises:
configuring the second LCC in the constant DC voltage mode, configuring the second VSC in the constant active power mode, decreasing first and second power references of the first VSC and the second VSC, respectively, to zero, and decreasing first and second power references of the first LCC and the second LCC, respectively, to zero, and increasing power flow via the first VSC and the second VSC in a power flow direction of the power flow deviation when the power support direction of the power order deviation is different from a power flow direction of the HVDC transmission system and the power order deviation is less than a sum of a total power change of the first VSC and the second VSC from the power reference of the VSC to reversed maximum power and the power reference of the first LCC and the second LCC.

20. The method of claim 13, wherein controlling the first terminal and the second terminal comprises:
configuring the second LCC in the constant DC voltage mode, configuring the second VSC in the constant active power mode, decreasing first and second power references of the first VSC and the second VSC, respectively, to zero, and decreasing first and second power references of the first LCC and the second LCC, respectively, to zero, increasing power flow via the first VSC and the second VSC to maximum power flow in a power flow direction of the power flow deviation, disconnecting the first LCC and the second LCC from the HVDC transmission system, reversing voltage polarity of each of the first LCC and the second LCC, reconnecting the first LCC and the second LCC to the HVDC transmission system, and increasing the power reference of the first LCC and the second LCC after reconnecting the first LCC and the second LCC to the HVDC transmission system when the power support direction of the power order deviation is different from a power flow direction of the HVDC transmission system and the power order deviation is less than a sum of a total power change of the first VSC and the second VSC from the power reference of the VSC to reversed maximum power and a total power change of the first LCC and the second LCC from the power reference of the LCC to reversed maximum power.

21. The method of claim 13, wherein controlling the first terminal and the second terminal comprises:
configuring the second LCC in the constant DC voltage mode, configuring the second VSC in the constant active power mode, decreasing first and second power references of the first VSC and the second VSC, respectively, to zero, and decreasing first and second power references of the first LCC and the second LCC, respectively, to zero, increasing power flow via the first VSC and the second VSC to maximum power flow in a power flow direction of the power flow deviation, disconnecting the first LCC and the second LCC from the HVDC transmission system, reversing voltage polarity of each of the first LCC and the second LCC, reconnecting the first LCC and the second LCC to the HVDC transmission system, and increasing the power reference of the first LCC and the second LCC to maximum capacity or greater after reconnecting the first LCC and the second LCC to the HVDC transmission system when the power support direction of the power order deviation is different from a power flow direction of the HVDC transmission system and the power order deviation is not less than a sum of a total power change of the first VSC and the second VSC from the power reference of the VSC to reversed maximum power and a total power change of the first LCC and the second LCC from the power reference of the LCC to reversed maximum power.
